(19) United States
(12) Patent Application Publication
(10) Pub. No.: US 2016/0292362 A1
(43) Pub. Date: Oct. 6, 2016

(54) COMPUTER-IMPLEMENTED WOUND CARE MANAGEMENT SYSTEM AND METHOD

(71) Applicant: Peter Thompson, Carrolton, TX (US)

(72) Inventor: Peter Thompson, Carrolton, TX (US)

(21) Appl. No.: 14/678,011

(22) Filed: Apr. 3, 2015

(51) Int. Cl. G06F 19/00; G06F 17/30

(52) U.S. Cl. CPC G06F 19/322; G06F 17/30312; G06F 19/3406

(57) ABSTRACT

Disclosed is a computer-implemented wound care management system employed by a health care entity, which either could be a health care organization or an individual health care professional. The system comprises a user interface for displaying, one at a time, a plurality of 3D human models, each of which representative of a patient registered with the health care entity. The surface of each human model comprises at least one wound marker that corresponds to at least one wound such that, the location of the at least one wound marker on the human model being same as the location the at least one wound on the patient's body. The system is configured such that, mousing-over a wound marker results in the corresponding wound details being displayed on the user interface.

### BACKGROUND

### FIELD OF THE INVENTION

The present invention relates to management information systems designed specifically for health care industry and more particularly relates to a computer-implemented wound care management system.

The flipside of conventional management information systems that are specifically designed for health care facilities, such as hospitals, is that they cluster all patients within the health care facility with their varying medical conditions, diseases, injuries, etc., together. This method of clustering might be effective in keeping track of all the patients within the health care facility but, on the flipside, fails to cater to specific groups of patients that share a common medical condition, disease, injury, etc. As a result, the health care personnel are forced to depend on an alternative systems or methods to keep track of the patients' treatment course sharing a common diseases, conditions, injuries, etc. Therefore, there is a relative gap in the market as far as the management information systems catering to specific set of patients are concerned. Secondly, as wounds (the subject of interest) are seen as fairly and relatively benign, there are not many information systems in the art that are tailor-made for the same. There is a need in the art for a management information system that is specifically designed for the surface wounds of patients.

### SUMMARY

The present invention comprises a computer-implemented wound care management system comprising a database comprising a plurality of patient entries, each of which representing a patient receiving medical attention from the health care entity. Each patient entry is associated with at least one wound entry, which represents a surface wound on the patient's body for which medical attention is being received. Each of the at least one wound entry is associated with a plurality of specification entries wherein, a specification entry represents a specification detail pertaining to the corresponding wound. Specification details include the location of the wound, size of the wound, drainage detail of the wound, odor of the wound, etiology of the wound, stage of the wound, necrotic tissue type of the wound, granulating tissue of the wound, necrotic tissue amount of the wound, surrounding tissue of the wound, signs/symptoms of infection, undermining of the wound, inflammation of the wound, wound care procedure being administered, and any comments by the assigned health care professional(s).

The system further comprises a user interface configured to a plurality of virtual 3D human models, one at a time selectively, wherein each human model is representative of a patient registered with the system. The skin of the human model is attached with at least one wound marker, which represents the at least one actual wound of the corresponding patient. More particularly, the location of the at least one wound marker on the human model being same as that of the at least one wound on the corresponding patient's body. The human model is configured to be rotated in 360° three-dimensionally about X, Y and Z axes so as to ensure the visibility of the wound marker all over the body of the human model.

The system is configured such that, mousing-over, selecting or actuating on a wound marker leads to the display of the corresponding wound specifications such that, the wound specifications do not interfere with the human model.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is a schematic block diagram of the wound care management system.

FIG. 2, according to an embodiment of the present invention, is an exemplary graphical representation of the variation of the dimensions of the wound over the treatment period of the wound.

FIGS. 3 through 6, according to an embodiment of the present invention, are exemplary screenshots of the various angles of the human model along with the wound specifications pertaining to a wound marking.

FIGS. 7 through 11, according to an embodiment of the present invention, are exemplary screenshots of the various angles of another subject model.

FIG. 12, according to an embodiment of the present invention, is an exemplary screenshot displaying the photograph of an actual wound.

FIG. 13, according to an embodiment of the present invention, is a flowchart of the wound care management method.

### FIGURES—REFERENCE NUMERALS

10—Computer-implemented Wound Care Management System

12—User Interface

14—User Terminal

16—Communications Network

18—Database

20—Virtual 3D Human Model

22—Wound Marking

24—Wound Specifications

26—Actual Wound

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

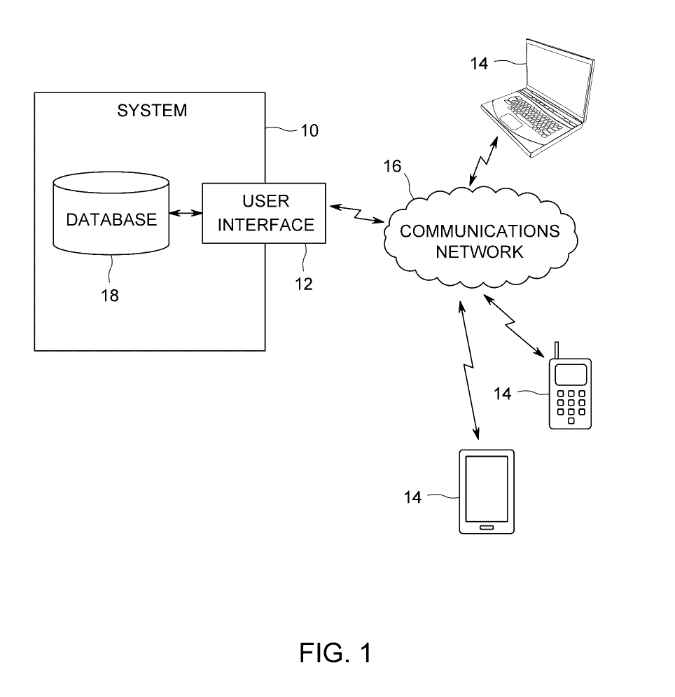

Embodiments of the present invention are directed to a computer-implemented wound care management system that is designed to be employed a health care entity, which could be a health care organization/facility (i.e., a hospital) or an individual health care professional, for the benefit of patients receiving medical attention from the health care entity. Referring to FIG. 1, the system 10 comprises a user interface 12 for enabling a user (i.e., a health care professional) to interact therewith. The user interface 12, which is provided by a website, a dedicated computer application, or the like, is facilitated by remote user terminals 14 such as, desktop computers, laptop computers, notebook computers, tablet computers, mobile phones, cellular phones, PDAs, etc., that capable of transacting data over a communications network 16, such as, the Internet, or the like.

Referring to FIG. 1, the system 10 comprises a database 18 disposed in operative communication with the user interface 12. The database 18 comprises a plurality of patient entries, each of which representing a patient receiving medical attention from the health care entity. Each patient entry is associated with general information pertaining to the patient and at least one wound entry. The general information of the patient includes the identification and address details of the patient including, the name, age, gender, photo, social security number, height, weight, build, complexion, address, phone number(s), date of birth, ethnicity of the patient, date on which the patient is attached to the health care entity, the health care professional(s) assigned to the patient, and any comments by the assigned health care professional(s). In one embodiment, each patient, upon being registered with the system 10, is associated with a unique patient identification code for purposes of easier reference. The system 10 is configured such that, the general information can be updated, modified or augmented via the user interface 12. In one embodiment, the system 10 is configured such that, the general information is updated, modified or augmented only by the health care professional(s) assigned to the patient.

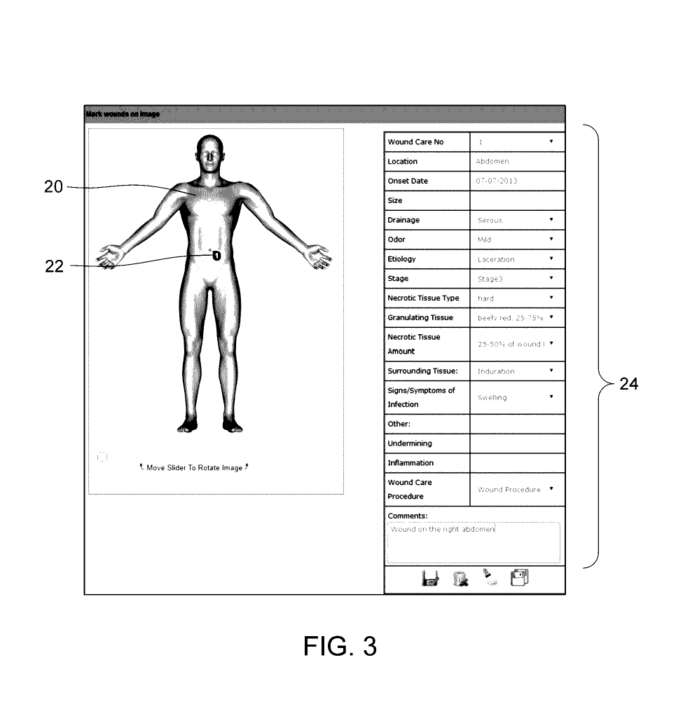

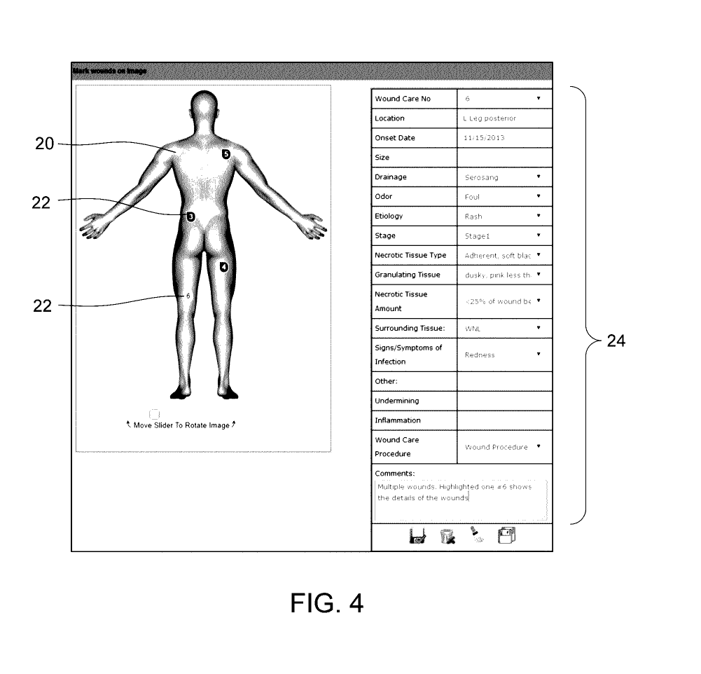

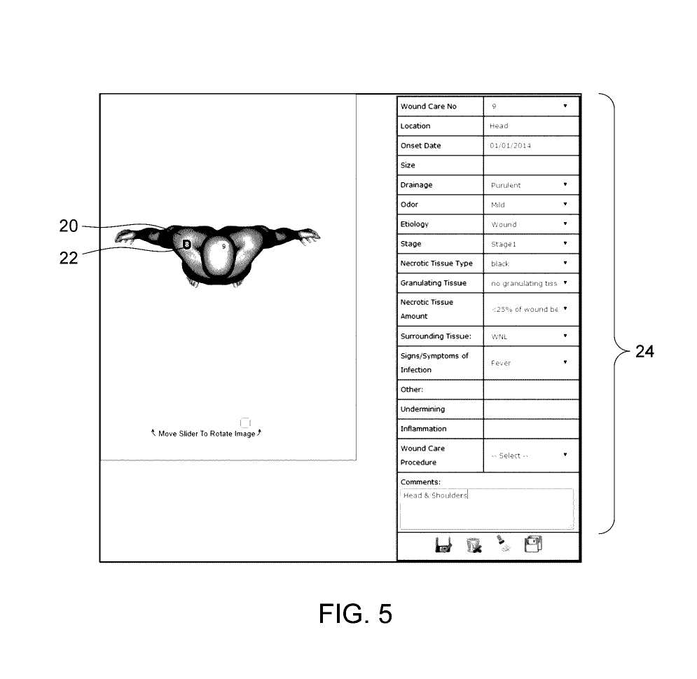

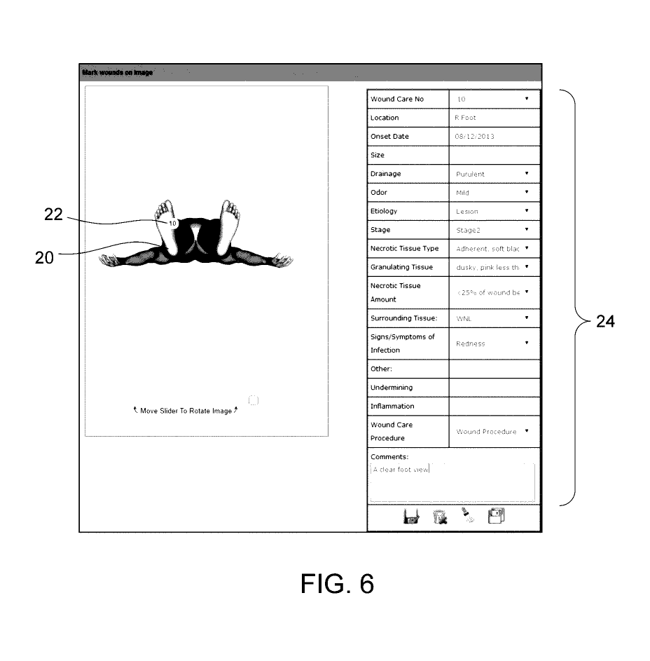

Referring to FIG. 1, each of the at least one wound entry represents a surface wound on the patient's body for which medical attention is being received. Each wound is assigned with a unique wound identification code for the purposes of easier reference. Each of the at least one wound entry is associated with a plurality of specification entries wherein, a specification entry represents a specification detail pertaining to the corresponding wound. As can be appreciated from FIGS. 3 through 6, specification details include the location of the wound, size of the wound, drainage detail of the wound, odor of the wound, etiology of the wound, stage of the wound, necrotic tissue type of the wound, granulating tissue of the wound, necrotic tissue amount of the wound, surrounding tissue of the wound, signs/symptoms of infection, undermining of the wound, inflammation of the wound, wound care procedure being administered, and any comments by the assigned health care professional(s). The system 10 is configured such that, the wound specifications can be updated, modified or augmented via the user interface 12. In one embodiment, the system 10 is configured such that, the wound specifications are updated, modified or augmented only by the health care professional(s) assigned to the patient.

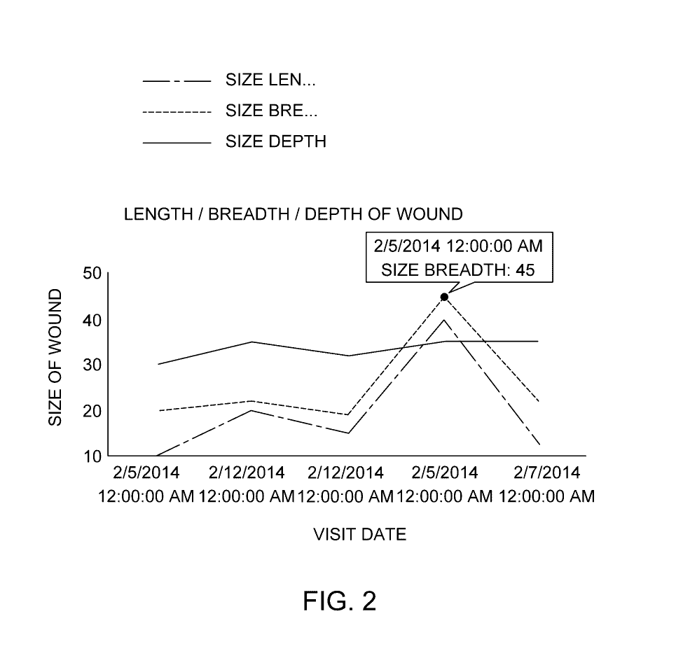

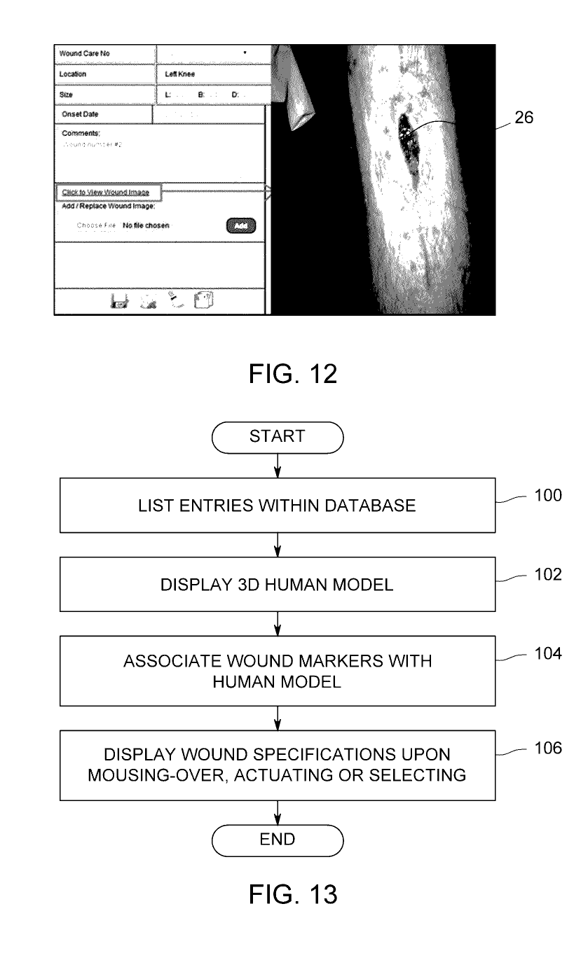

Referring to FIG. 1, each of the at least one wound entry is further associated with progress information, which comprises chronological periodical information pertaining to the corresponding wound from the time of the commencement of the medical treatment for the wound till the time of the completion of the medical treatment for the wound or till date in the event of the corresponding would is being still treated. The progress information of a wound includes a log report comprising the date and time on which the wound has received a pre-assigned medical checkup, the identity of the professional who has performed the medical checkup, the procedure of the medical checkup performed, a photograph of the wound (see FIG. 12), current wound specifications, and any comments left by the health care professional. As can be appreciated from FIG. 2, the progress information further includes a graphical representation (hereinafter “graph”) of the variation of the dimensions of the wound over the treatment period of the wound.

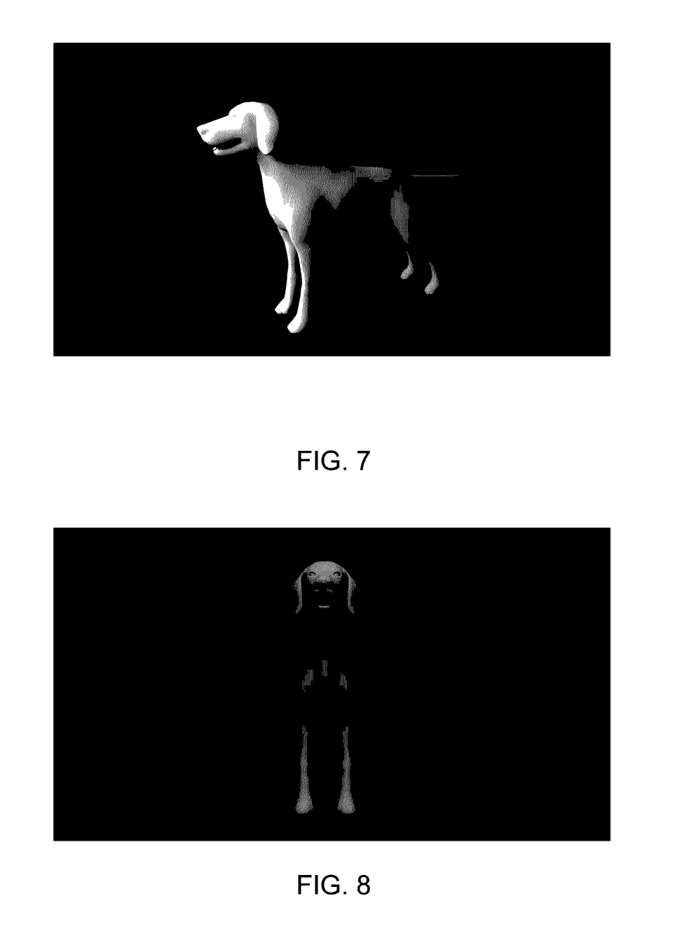

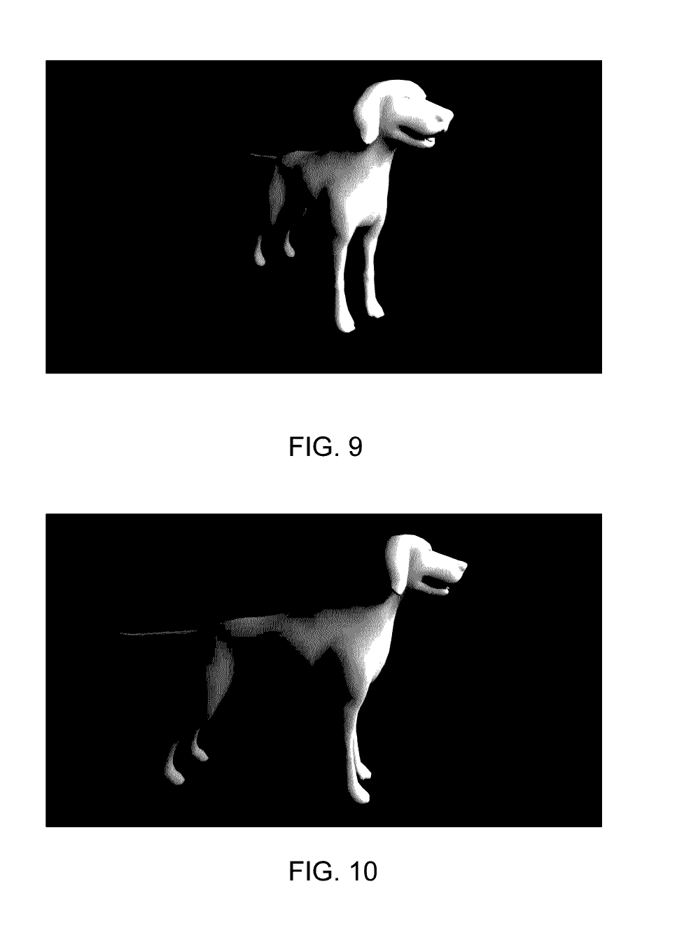

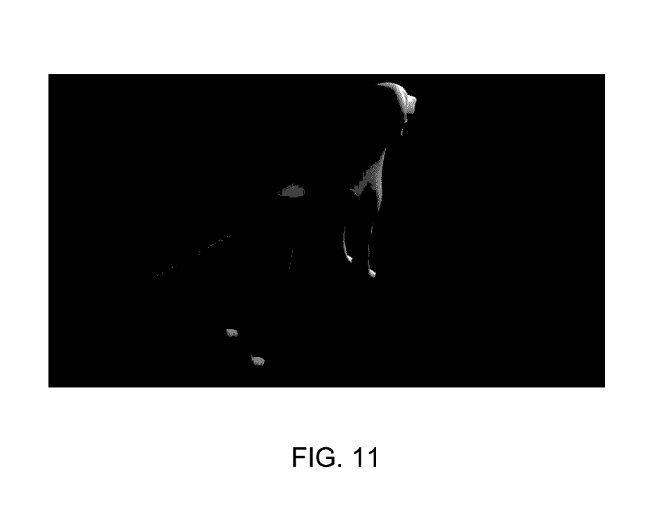

Referring to FIG. 1, the user interface 12 is configured to a plurality of virtual 3D human models 20, one at a time selectively, wherein each human model 20 is representative of a patient registered with the system. In one embodiment, the body characteristic of a human model 20 is same as that of or closer to that of the patient's. The skin of the human model 20 is attached with at least one wound marker 22, which represents the at least one actual wound of the corresponding patient. More particularly, the location of the at least one wound marker 22 on the human model 20 being same as that of the at least one wound on the corresponding patient's body. As can be appreciated from FIGS. 3 through 6, the human model 20 is configured to be rotated in 360° three-dimensionally about X, Y and Z axes so as to ensure the visibility of the wound marker 22 all over the body of the human model 20. Similarly, FIGS. 7 through 11 depict another example of the 360° rotation of another subject model (dog). Further, the human model 20 is configured to be selectively movable between a plurality of body posture positions. The plurality of posture positions (not shown) include the upright position with the arms down, the upright position with the arms up parallel to the body, the upright position with the arms being perpendicular to the body and the palms open. The plurality of body positions ensure the visibility of those wound markers 22 that are earlier covered by the body parts in an earlier posture position. For example, a wound marker 22 on the armpit of the human model 20, which is not visible in the upright posture position with the arms down, is visible in the upright posture position with the arms up. Further, the human model 20 is configured to be zoomed onto for a closer view thereof.

As can be appreciated from FIGS. 1 through 6, the system 10 is configured such that, mousing-over, selecting or actuating on a wound marker 22 leads to the display of the corresponding wound specifications 24 such that, the wound specifications 24 do not interfere with the human model 20. In one embodiment, the displayed wound specification 24 information comprises a prognosis link, which, when actuated, displays the progress information including the aforementioned graph. Notably, as can be appreciated from FIG. 7, in one embodiment, a current photograph of the actual wound 26 is attached with every routine checkup (as per the log report) of the wound.

Referring to FIG. 13, the computer-implemented wound care management method initiates with listing (step 100) a plurality of patient entries within a database wherein, a patient entry represents a patient receiving medical attention from the health care entity. Each patient entry is associated with general information pertaining to the patient and at least one wound entry. The general information of the patient includes the identification and address details of the patient including, the name, age, gender, photo, social security number, height, weight, build, complexion, address, phone number(s), date of birth, ethnicity of the patient, date on which the patient is attached to the health care entity, the health care professional(s) assigned to the patient, and any comments by the assigned health care professional(s). In one embodiment, each patient is associated with a unique patient identification code for purposes of easier reference.

Referring to FIG. 13, the method further includes displaying (step 102) a virtual 3D human model, which is representative of a patient wherein, the skin of the human model is attached (step 104) with at least one wound marker, which represents the at least one actual wound of the corresponding patient. More particularly, the location of the at least one wound marker on the human model being same as that of the at least one wound on the corresponding patient's body. The human model is configured to be rotated in 360° three-dimensionally about X, Y and Z axes so as to ensure the visibility of the wound marker all over the body of the human model. Further, the human model is configured to be selectively movable between a plurality of body posture positions. The plurality of posture positions (not shown) include the upright position with the arms down, the upright position with the arms up parallel to the body, the upright position with the arms being perpendicular to the body and the palms open. The plurality of body positions ensure the visibility of those wounds that are earlier covered by the body parts in an earlier posture position. For example, a wound on the armpit of the human model, which is not visible in the upright posture position with the arms down, is visible in the upright posture position with the arms up. Further, the human model is configured to be zoomed onto for a closer view thereof.

Referring to FIG. 13, the method further includes displaying (step 106) the corresponding wound specifications upon mousing-over, actuating, or selecting a wound marker on the human body such that, such that, the wound specifications do not interfere with the human model. In one embodiment, the displayed wound specification information comprises a prognosis link, which, when actuated, displays the progress information including the aforementioned graph.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of

Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A computer-implemented wound care management system purposed to be employed by a health care entity, the heath care entity being either a health care organization or an individual health care professional, the system comprising:
(a) a database comprising a plurality of patient entries, each of which representing a patient registered with the health care entity, each patient entry associated with general information thereof comprising identification details and address details, each patient entry further associated with, at least one wound entry, each of the at least one wound entry representing a surface wound on the corresponding patient's body for which, medical treatment is being received from the health care entity, each of the at least one wound entry in turn associated with a plurality of specification entries, each specification entry representing a specification of the wound, each of the at least one wound entry further in turn associated with a progress information, which comprises chronological periodical information pertaining to the corresponding wound from the time of the commencement of the medical treatment for the wound till the time of the completion of the medical treatment for the wound or till date in the event of the corresponding would is being still treated; and
(b) a graphical user interface for enabling a user to interact therewith over a communications network, the user interface configured to display a plurality of virtual 3D human models, each of which representative of a patient registered with the health care entity, the surface of each human model associated with at least one wound marker that corresponds to the corresponding at least one wound entry, the location of the at least one wound marker on the human model being same as the location the at least one wound on the patient's body, the human model adapted to rotatable in 360° about x, y and z axes;
wherein, mousing-over, actuating, or selecting a wound marker results in the corresponding wound details being displayed on the user interface, the wound details comprising the wound specifications and progress information.

2. The system of claim 1 wherein, the wound specifications include the location of the wound, size of the wound, drainage detail of the wound, odor of the wound, etiology of the wound, stage of the wound, necrotic tissue type of the wound, granulating tissue of the wound, necrotic tissue amount of the wound, surrounding tissue of the wound, signs/symptoms of infection, undermining of the wound, inflammation of the wound, wound care procedure being administered, and comments of the professional or professionals treating the wound.

3. The system of claim 1 wherein, the wound specifications are adapted to be modified or augmented.

4. The system of claim 1 wherein, the progress information of a wound includes a graphical representation of the variation of the size of the wound over the treatment period of the wound.

5. The system of claim 1 wherein, the progress information of a wound includes a log report comprising the date and time on which the wound has received a pre-assigned medical checkup, the identity of the professional who has performed the medical checkup, the procedure of the medical checkup performed, a photograph of the wound, current wound specifications, and comments left by the professional.

6. The system of claim 1 wherein, the body characteristic of the human model is similar to the body characteristic of the corresponding patient.

7. The system of claim 1 wherein, the human model is adapted to be selectively movable between a plurality of body posture positions.

8. The system of claim 7 wherein, the plurality of posture positions include, the upright position with the arms down, the upright position with the arms up parallel to the body, the upright position with the arms being perpendicular to the body and the palms open

9. The system of claim 7 wherein, the human model is adapted to be three-dimensionally rotated in 360° in each of the plurality of posture positions.

10. The system of claim 1 wherein, the user interface is configured to display a plurality of virtual 3D human models, one human model at a time.

11. The system of claim 1 wherein, mousing-over, actuating, or selecting a wound marker results in the corresponding wound details being displayed on the user interface such that, the wound details do not interfere with the human model.

12. The system of claim 1 wherein, the human model is configured to be zoomed onto.

13. A computer-implemented wound care management method employed by a health care entity, the heath care entity being either a health care organization or an individual health care professional, the method comprising:
(a) listing within a database, a plurality of patient entries, each of which representing a patient registered with the health care entity, each patient entry associated with general information thereof comprising identification details and address details, each patient entry further associated with, at least one wound entry, each of the at least one wound entry representing a surface wound on the corresponding patient's body for which, medical treatment is being received from the health care entity, each of the at least one wound entry in turn associated with a plurality of wound specification entries, each specification entry representing a specification of the wound, each of the at least one wound entry further in turn associated with a progress information, which comprises chronological periodical information pertaining to the corresponding wound from the time of the commencement of the medical treatment for the wound till the time of the completion of the medical treatment for the wound or till date in the event of the corresponding would is being still treated; and
(b) displaying via a graphical user interface a plurality of virtual 3D human models, each of which representative of a patient registered with the health care entity, the surface of each human model associated with at least one wound marker that corresponds to the corresponding at least one wound entry, the location of the at least one wound marker on the human model being same as the location the at least one wound on the patient's body, the human model adapted to rotatable in 360° about x, y and z axes;
wherein, mousing-over, actuating, or selecting a wound marker results in the corresponding wound details being displayed on the user interface, the wound details comprising the wound specifications and progress information.

14. The method of claim 13 wherein, the wound specifications include the location of the wound, size of the wound, drainage detail of the wound, odor of the wound, etiology of the wound, stage of the wound, necrotic tissue type of the wound, granulating tissue of the wound, necrotic tissue amount of the wound, surrounding tissue of the wound, signs/symptoms of infection, undermining of the wound, inflammation of the wound, wound care procedure being administered, and comments of the professional or professionals treating the wound.

15. The method of claim 13 wherein, the wound specifications are adapted to be modified or augmented.

16. The method of claim 13 wherein, the progress information of a wound includes a graphical representation of the variation of the size of the wound over the treatment period of the wound.

17. The method of claim 13 wherein, the progress information of a wound includes a log report comprising the date and time on which the wound has received a pre-assigned medical checkup, the identity of the professional who has performed the medical checkup, the procedure of the medical checkup performed, a photograph of the wound, current wound specifications, and comments left by the professional.

18. The method of claim 13 wherein, the body characteristic of the human model is similar to the body characteristic of the corresponding patient.

19. The method of claim 13 wherein, the human model is adapted to be selectively movable between a plurality of body posture positions.

20. The method of claim 19 wherein, the plurality of posture positions include, the upright position with the arms down, the upright position with the arms up parallel to the body, the upright position with the arms being perpendicular to the body and the palms open

21. The method of claim 19 wherein, the human model is adapted to be three-dimensionally rotated in 360° in each of the plurality of posture positions.

22. The method of claim 13 wherein, the user interface is configured to display a plurality of virtual 3D human models, one human model at a time.

23. The method of claim 13 wherein, mousing-over, actuating, or selecting a wound marker results in the corresponding wound details being displayed on the user interface such that, the wound details do not interfere with the human model.

24. The method of claim 13 wherein, the human model is configured to be zoomed onto.
